(19) United States
(12) Patent Application Publication
(10) Pub. No.: US 2009/0116706 A1
(43) Pub. Date: May 7, 2009

(54) Device and procedure for the recording of lines of the fingers respectively the hand

(76) Inventor: Rudolf Hauke, Niederstotzingen (DE)

Correspondence Address: JACOBSON HOLMAN PLLC, 400 SEVENTH STREET N.W., SUITE 600, WASHINGTON, DC, 20004, US

(21) Appl. No.: 11/920,250

(22) PCT Filed: Jul. 19, 2005
(86) PCT No.: PCT/EP2005/007869

§ 371 Date: Dec. 2, 2008

(30) Foreign Application Priority Data
May 13, 2005 (DE) 10 2005 023 093.8

(51) Int. Cl. G06K 9/00

(52) U.S. Cl. 382/126; 382/124

(57) ABSTRACT

The invention refers to a device for the recording of the lines of the fingers respectively the hand. The device has a support area for the hand respectively the fingers. In the support area a line sensor is provided which extends across the overall width of the hand.

The invention concerns a device respectively a method for the recording of the lines of the fingers respectively of the hand.

Aforementioned devices and methods are for example known from the international patent application PCT-EP 2005-000588 by the applicant.

From the state of the art it is furthermore known to execute a sequential progression of the recording of lines of the fingers respectively the hand. This kind of method is comparatively time-consuming.

For the large-area recognition of the lines of the fingers of the hand for example large optically imaging systems are known, which are comparatively complex.

The invention has made it its task to suggest a device for the recording of the lines of the fingers respectively of the hand which is designed in a more simple and therefore also more cost-saving way.

Proceeding on this description of the task the inventor makes the suggestion that a support area for the hand respectively for the fingers is provided and that in this support area a line sensor is provided which covers the entire width of the hand.

For the recording of the fingers respectively of the hand lines there is now the necessity of a relative movement between the hand and the line sensor. Contrary to the state of the art, where a so-called “portrait”-picture was made, which meant that the surface to be recorded had to be kept without motion, the suggestion according to the invention now produces a sequence of comparatively narrow-striped image segments, which then are processed by means of image editing technology and finally put together to one overall picture.

The advantage of this kind of construction is considerable. Firstly, the effort needed for the construction according to the invention is reduced considerably, as only a comparatively small line sensor has to be used. The result is a device that can be built at a comparatively small size.

The invention comprises in this case both a solution in which a line sensor extending longitudinally is provided and an arrangement of several line sensors side by side respectively in staggered position side by side, which are suitable to record a certain part of the length of the hand.

In one preferred modification of the invention it is intended that the device is equipped with at least one finger superficies surface recognition arrangement. This combination of a finger superficies surface recognition arrangement with the line sensor provides the possibility to execute comparatively complex images in only one processing step. The process is comparatively complex, because the fingers close to the hand are to be considered as parallel cylinders or cylinders in an acute-angled arrangement which are in a comparatively narrow arrangement next to each other and the characteristic finger superficies surfaces are positioned comparatively close to each other. One individual rolling movement of the finger to attain a superficies surface that is as comprising as possible would be one possibility, but this procedure is very time-consuming. If, however, one adequate finger superficies surface recognition arrangement is provided for every individual finger the simple positioning of the fingers on the support area of the device according to the invention achieves that both the respective superficies surfaces of the fingers and the lines of the hand respectively of the fingers are recorded. This whole process takes place while the hand is inserted and/or removed from/into the device one time.

A corresponding finger superficies surface recognition arrangement is, for example, known from the international patent application PCT-EP 2005-001230 by the applicant. The content of this patent application is the subject for reference here in full scope and is considered an integral component of this application.

To facilitate the recording of the finger superficies surfaces it is convenient that in the device several splaying means for the fingers are provided. These are preferably arranged at, on or above the support area. The splaying means are, for example, designed in pin shape or in cylinder shape and will be inserted in the spaces between the individual fingers. A similar proceeding can be effected by means of appropriate grooves in the support area.

In one preferred modification of the invention it is provided that there is at least one lateral contact area for guidance of the side respectively the edge of the hand to be provided. A contact area of this kind facilitates the operability of the device considerably. At the same time it is, however, possible that inside the contact area an image sensor is arranged which serves, for example, to record the biometric information of the edge of the hand or the lines of the back of the hand.

In this case it is provided that a corresponding contact area is not only provided for the edge of the hand alone, but, for example, also guides the side of the hand between the forefinger and the thumb. Here it is possible that these areas as well are scanned with another image sensor accordingly and that the lines are recorded accordingly.

The conclusion is in another advantageous modification of the invention that the hand is guided laterally by one contact area each. One of these contact areas supports the hand at the edge of the hand, the other possibly supports the finger area of the hand at the forefinger. Of course it is optionally possible to equip both contact areas with one image sensor each as well.

In this connection the invention also provides in one modification that one contact area is of course also provided for the back of the hand, this means for the upper side of the hand. In this case, for example, the position of this contact area is variable, it can be slightly moved backwards. Thus it is on principle also possible to record the back of the hand as well, namely if the respective contact area is also equipped with an image sensor.

Cleverly the support area with the range of the finger superficies surface recognition arrangement is excepted in order to not disturb the beam path or diminish the quality of the image by staining at contact surfaces.

It is thereby achieved to record the biometric information that means the lines of the hand respectively the fingers without touch. By a corresponding exception in the support area or the respective distance or the absence of other support areas for the fingers a distortion-free image is possible that is not falsified by respective distortions due to pressing the fingers on the respective surfaces and so on.

In order to record all necessary image information as quickly as possible it is convenient that for every finger one individual finger superficies surface recognition arrangement is provided.

In one preferred version of the invention it is provided that the finger superficies surface recognition arrangement consists of one deflection mirror possibly one image optics as well as one image recording unit. The use of one deflection mirror allows the image recording unit for the recognition of the finger superficies surfaces to be executed at a different place. This sort of arrangement can therefore be used for the purpose of optimising the arrangement of positions. Optionally the use of image optics is favourable, it can be done without, if it is not required.

Moreover the invention provides that conveniently the deflection mirrors of neighbouring finger superficies surface recognition arrangements are arranged in staggered position to each other. As the angle area between the fingers is comparatively restricted and the test person should not experience too extreme splaying of the fingers which would be uncomfortable it is advantageous to arrange the (for example large-size) deflection mirrors of neighbouring finger superficies surface recognition arrangements in a staggered position to avoid impending space conflicts.

The same applies of course if one finger superficies surface recognition arrangement possesses several deflection mirrors, whereas then possibly one part of these deflection mirrors of a finger superficies surface recognition arrangement can be positioned in a staggered way to each other.

In another advantageous embodiment of the invention it is provided that the finger superficies surface recognition arrangement comprises several deflection mirrors and that every deflection mirror displays individual areas of the finger superficies surface. This sort of division of the recognition of finger superficies surfaces among several deflection mirrors can offer advantages when implementing the respective devices according to the invention. Thus it is even possible to utilise comparatively simple, planar deflection mirrors which are then each arranged around the finger in an angular way.

The deflection mirrors are in this case preferably arranged edge to edge to deliver an image that is as interruption-free as possible. In this sort of application plane deflection mirrors that are easier to produce can be utilised.

Moreover the invention provides that die image recording unit is a plane image sensor or a line sensor. A two-dimensional sensor or a camera for example may in this case be defined as plane image sensor. They are for example executed in CCD-technology and readout can be effected line-wise. For example when using a ring-shaped deflection mirror a ring-shaped image will be projected onto an two-dimensional image recording unit. But it is also possible to design the image recording unit as a line sensor. The two-dimensional display will then be achieved by an accordingly speedy readout of the sensor (similar to the two-dimensional image sensor). In general the suggested image sensor respectively line sensors will in the following be described as sensors. Conveniently it is provided in the invention that the sensor, for example, is designed to be a colour camera and thus can record colour images.

The width of the sensors is—in comparison to the surface to be recorded—small, as ultimately a recording film is used preferably for the draw-back movement (or else relative movement) of the hand respectively the finger opposite the image recording unit. The recorded images will then be put together to a two- or three-dimensional picture. Thus regular readout of the image information is also necessary in case of a plane image sensor, whereas this sort of sensor contains accordingly more information and possibly readout can be effected at lower interval rates.

In this case the use of a line sensor is advantageous, because readout is done much faster and therefore a higher amount of data can be delivered, thus improving the quality of the image as per line unit a higher amount of image information per period of time can be generated.

In one preferred modification of the invention it is moreover suggested that the areas of the finger superficies surface recorded by one of several deflection mirrors are each recorded by one area of the line sensor. Although a majority of deflection mirrors, preferably especially planar deflection mirrors are provided in one finger superficies surface recognition arrangement the respectively deflected image information will again be transmitted to a sensor respectively preferably a line sensor. Especially the use of a line sensor that enables quick readout combines the simple embodiment of the sensor, a simple embodiment of the deflection mirror, especially as planar mirror, with the quick readout speed of a corresponding line sensor. In particular when a high amount of data has to be collected this is advantageous.

Cleverly in this case the neighbouring deflection mirrors will display the respective finger superficies surfaces on neighbouring sensor areas. This facilitates the image composition afterwards considerably. Of course it is possible to vary the sequence accordingly, especially if this is more favourable with regard to the optical beam path of the information.

Alternatively it is of course provided that, instead of one sensor for the majority of deflection mirrors, one individual sensor is provided for each deflection mirror. In this case smaller, individual sensors can be provided which are then each quicker read out. Readout has to be correlated, this means it has to be effected in cycles or in a triggered way. The image information is in this case not added to one complete image line by line, but at first the lines of the individual partial areas are generated and then put together. By this embodiment the speed for readout of the images increases, however, time and effort needed to complete the individual images to one complete picture afterwards increase as well.

Moreover in one preferred version of the invention it was found that the use of light of different wave lengths for illumination of the finger respectively of the hand is used to serve especially for the production of a three-dimensional image of the finger superficies surface respectively the hand.

By this method known as fractal image processing it is possible to attain three-dimensional images in a comparatively easy way.

In this case especially the use of one-colour respectively multicolour illumination and the combination with a colour camera are advantageous. For example the colour camera is arranged in the middle of the surface to be monitored. The two luminous sources are arranged in a symmetric way in front of and behind the scanning level. If the normal vector of the scanned surface is directed towards the camera level then the camera will see—due to the symmetric arrangement—both colours in equal shares. If the surface is bent towards one direction, as for example in case of a groove the reflection angles change and the colour proportions become asymmetric. From the relation of the colour proportions conclusions can be drawn regarding the incline of the surface. When subtracting the two components from each other plane surface components disappear whereas the respective elevations or depressions are clearly silhouetted against the background in 3-D-structure. This form of embodiment is, for example, also possible analogously by using normal illumination or the use of a “white lamp”.

With regard to the embodiment of the deflection mirror the invention is very variable. For example it is possible to use a ring-shaped or a half-ring shaped deflection mirror which—as to be described in the following—leads to very good results. But it is also possible in the same way to use a plane respectively a planar or else a truncated-conical-shaped deflection mirror, whereas especially the plane respectively the planar deflection mirror is considerably more advantageous in its production.

For the use of the ring-shaped or half-ring shaped deflection mirror it is convenient that the arc angle of the ring respectively the half-ring covers 0° to 360°, preferably 0° to 220°, most preferably 0° to 180°. In its view the arc angle describes the area of the angle in which the ring-shaped respectively half-ring shaped deflection mirror is arranged. As a recording from nail to nail is the aim to be achieved it may suffice for certain applications to implement a half-ring shaped embodiment whereas here, for example, an angle area of up to 220° is convenient in order to also display the adjacent finger areas reliably. In a slightly more basic embodiment a half-ring shaped modification up to 180° can already be sufficient.

It is, however, also possible to implement for example only the arc angle of 60°, 90° or 45°. In such a case the deflection mirrors are arranged in a straight way on the bottom side of the fingers and preferably display especially these areas. Of course it is also possible to use different segments of smaller arc angles of capacious deflection mirrors. This may be of advantage in arrangements with shortage of space.

In one even more basic modification it is provided that the finger superficies surface recognition arrangement is formed by an individual line sensor.

One essential advantage of the invention lies especially in the fact that the complete device according to the invention is designed in a modular way. Thus it is possible that, for example, the used line sensor itself is designed in a modular way. But it is also convenient that, depending on the desired equipment, the device can than individually be equipped with a finger superficies surface recognition arrangement and/or an image sensor, for example for recording of the edge of the hand respectively of other areas of the hand sides. Thus it is possible to adjust the advice to the respective customer requests, in accordance with a unit assembly system, and to implement it.

It is also convenient that for example the line sensor, the finger superficies surface recognition arrangement respectively the image sensor or their contact areas are each designed in a modular way, thus the assembly is to be implemented in a convenient way accordingly. It is for example possible to choose the arrangement in a way that with one image optics different mirrors work together in the finger superficies surface recognition arrangement.

In one preferred embodiment of the invention it is provided that an image recording scanner, especially at a splaying means, is provided which serves to start recording of the finger respectively superficies surface line and/or the individual finger superficies surfaces. By means of the image recording scanner as suggested in the invention the test person himself/herself ultimately triggers the recording of the lines of the fingers respectively the hand. The test person has to insert his hand into the device in a way that the image recording scanner is actuated. The recording of the image will then preferably be effected during the draw-back movement of the hand thus also making sure that the relative movement is effected. This facilitated data processing and increases data security.

According to the invention it is of course also possible to generally provide a relative movement of the hand relative to the device for use according to the invention, this means, both the use of the device and the use of the method according to the invention is possible during the insertion movement and the draw-back movement as well.

The arrangement of the image recording scanner is preferably provided at a splaying means, whereas the arrangement then is chosen in a way that the image recording scanner cannot be actuated accidentally, but only when the hand is inserted completely and, for example, the intermediate area between two fingers rests against the surface of the splaying means. Then, for example the image recording scanner is also actuated. If necessary further adequate switches or scanners that are in correlation to each other can be provided to safely avoid any accidental or faulty operation. The test person will be informed about this by a respective acoustic or visual message, then he draws back his hand and the lines are recorded accordingly.

Beside an actuation of the image recording scanner by the intermediate area between two fingers it is possible in another embodiment of the invention, that for example the fingertips actuate the image recording scanner. In this case the image recording scanner is not located on the splaying means.

Moreover it is suggested in accordance with the invention that the deflection mirror is to be arranged in the vicinity of the splaying means.

It is the aim of the use of the deflection mirror to reproduce the finger superficies surface as completely as possible, namely with regard to the arc angle and with regard to the length of the finger. The recording of the finger superficies surface is in this case also preferably effected by the draw-back movement of the hand. If now the deflection mirror is arranged as closely as possible to the root of the finger it is possible to record the whole finger. As regards design-engineering this means that the deflection mirror has to be positioned as closely as possible to or in the area of the splaying means as the splaying means will be positioned in the angle area between two fingers, i.e. the start of the root of the finger.

Therefore it is in the sense of the invention already sufficient that regarding the insertion movement respectively draw-back movement of the hand the deflection mirror is positioned on the same level as the splaying means for thus being in the vicinity.

In order to further optimise the required period of time for recording of the lines of the hand respectively of the finger a recording unit is suggested which serves to record the lines of the fingers respectively of the hand of a test person. This unit consists of a double, preferably mirrored arrangement of two devices, as described. A recording unit of this kind is characterised by a very basic and therefore cost-saving assembly, at the same time recording of both hands simultaneously reduces the time for recording considerably. The waiting time for the test person, for example in case of respective access control, sinks accordingly.

The task given at the beginning is also solved by a method for recording of the lines of the fingers respectively the hand whereas the recording of the finger superficies surfaces is effected simultaneously with the recording of the lines of the hand. By this simultaneous process of the recordings the time required for recording, i.e. the time the respective test person has to stay at the device, is reduced considerably.

The recordings are in this case effected regionally separated in a way that the finger superficies surface in the front area is preferably recorded by the described finger superficies surface recognition arrangement and the lines of the hand by a different sensor, for example the line sensor as just described. Of course the finger superficies surface recognition arrangement does also record the finger lines of the finger superficies surface, as the lines of the fingers respectively the hand are person-identifying.

It is conveniently provided that a comparison, a control respectively an assignment of the recorded finger superficies surfaces to the respectively recorded finger bottom sides is effected. Hereby the data security respectively the correctness and the authenticity of the data is increased accordingly, this of course improves the quality of the information. It is especially also provided that, should there be a trembling movement of the hand, an image correction step is effected before, during or after the control step of the method. This image correction step consists of one algorithm for elimination of the trembling movement, as used in photography for example. In this case it has to be made sure that the image processing in addition generates from the recorded film of the finger superficies surfaces one complete image.

In one preferred modification of the method it is provided that especially by the use of colour sensors respectively colour cameras a three-dimensional image of the finger superficies surface respectively the hand is generated. Accordingly the sensor of the image recording unit of the finger superficies surface recognition arrangement or the line sensor for recording the bottom side of the hand for example are designed to be a colour sensor, to generate the respective coloured images. With the aid of an image processing respectively image editing, using the effect of fractal light (as described above, which is referred to in full scope in the method according to the invention) it is now possible to extract a three-dimensional image by calculation from the planar image information achieved in any optional way. The information of the different colour-intensive areas of the sensor are calculated and evaluated in a suitable way. By doing so it is possible to achieve a three-dimensional image with very little effort, for example by using only planar mirrors and applying the above described method.

In the drawings the invention is demonstrated in a schematic way. They show

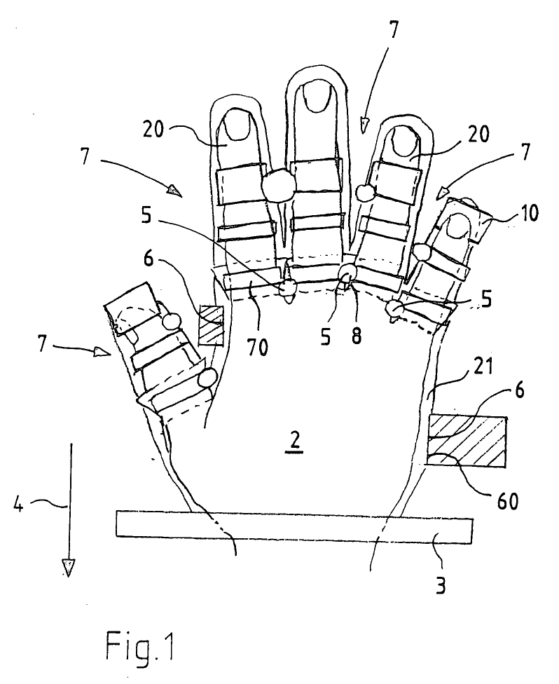

FIG. 1: a top view on the device according to the invention;

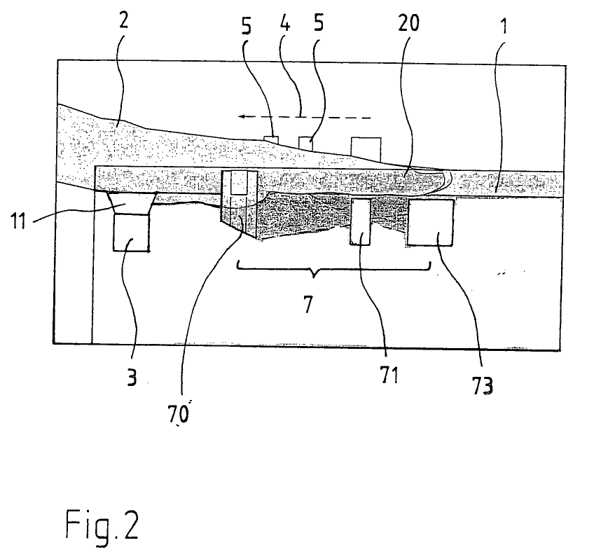

FIG. 2: a lateral view of the device according to the invention;

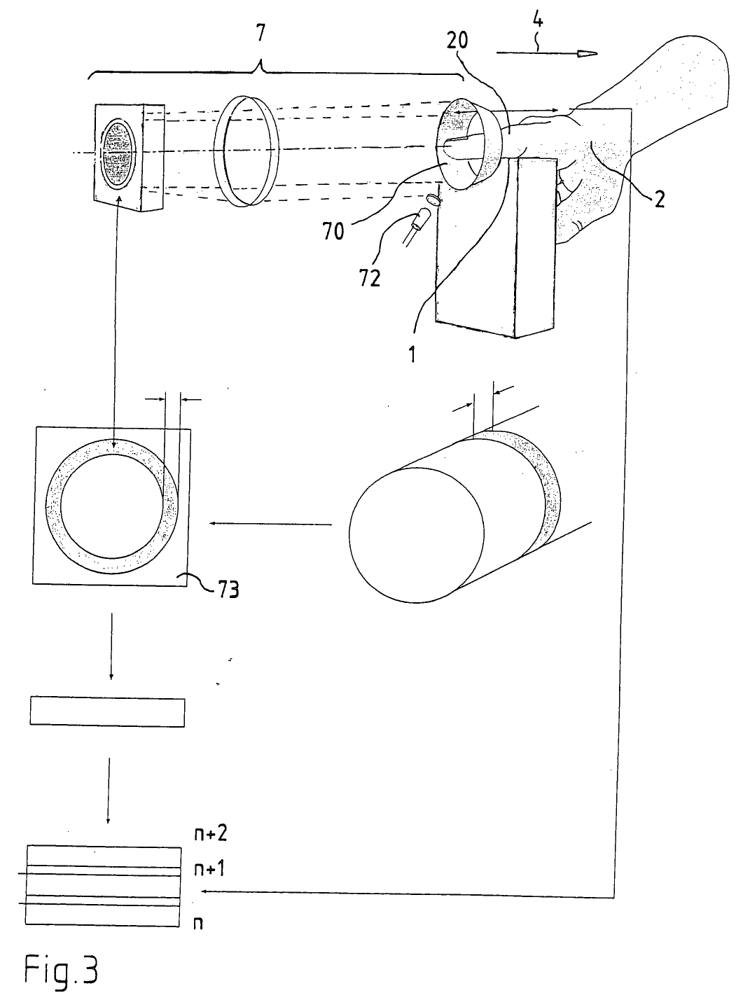

FIG. 3: in one general survey view the mode of operation of the finger superficies surface recognition arrangement regarding the device according to the invention

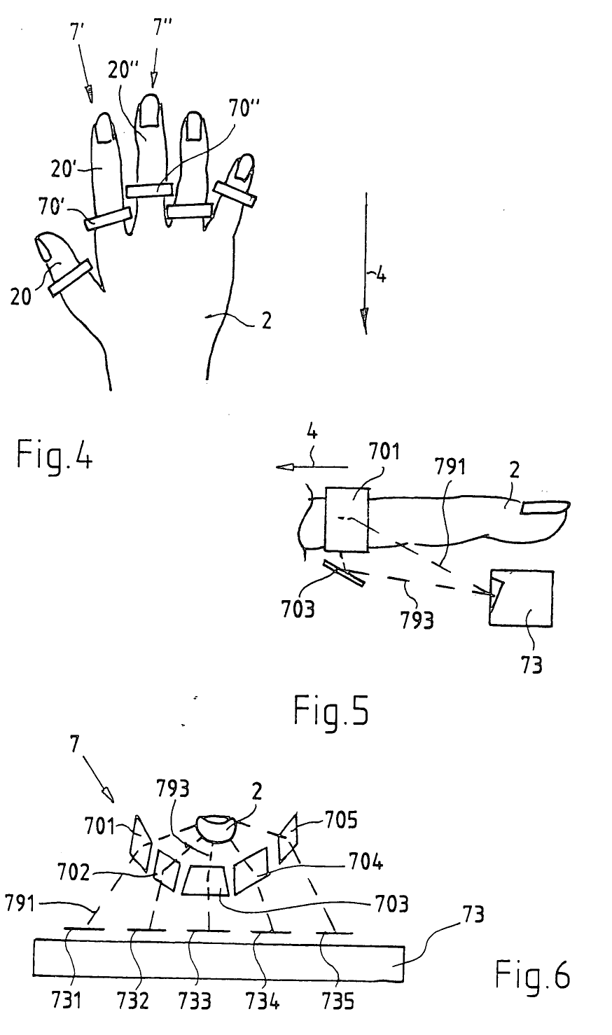

FIG. 4: a top view of another modification of the device according to the invention

FIG. 5: in one lateral view one modification of the finger superficies surface recognition arrangement regarding the device according to the invention and

FIG. 6: a top view according to FIG. 5

The mode of operation has to be elucidated in particular in synopsis of FIG. 1 and FIG. 2.

In accordance with the invention a device for recording the lines of the fingers respectively the hand is suggested, whereas the device provides a support area 1 for the hand 2 respectively the fingers 20. In the support area 1 a line sensor 3 is arranged. It is easy to perceive that the line sensor 3 (FIG. 1) illustrated here is wider than the hand 2.

To avoid staining of the line sensor 3 is has to be provided that in the support area 1 there is a groove 11 and thus a distance between the hand area and the surface of the line sensor 3 facing the hand exists.

FIG. 1 shows that the length of the support 1 is determined in a way that the whole hand can rest on it. One essential advantage of the invention lies especially in the fact that in one step a multitude of biometric data, that is to the say of the lines of hands and fingers, are gained in a mix-up-proof way. Data that are comparatively easy to attain, that is to say the lines of the fingers respectively the hand at the bottom of the hand, but also data that are comparatively complex to attain of the finger superficies surface are recorded simultaneously. Nevertheless the complete device is of short length, this is achieved mainly due to the line sensor 3 having a clearly smaller width in comparison with the hand 2. In order to record the complete bottom side of the hand by the line sensor 3 a relative movement 4 is required. This relative movement 4 is achieved by a draw-back movement 4 of the hand 2 in the execution example implemented here. This is also indicated by the arrow in FIG. 2. Of course it is also possible to develop the line sensor 3 in arbour-shape and to provide it beginning at the root of the hand proceeding to the front to achieve a recording this way as well. Both modifications are part of the invention although the modification with fixed line sensor 3 offers advantages, as no additional actuation has to be provided and the test person has to move his hand anyhow.

For achieving a guiding of the hand to be recorded 2 that is as exact as possible different means are provided. Firstly, contact areas 6 are provided which for example guide the side of the hand 21. This kind of contact areas 6 are located at the left and right side of the hand in a way that the hand is guided in between. The thumb is splayed to the left from the left contact area 6 (compare FIG. 1).

The contact area 6 is, for example, designed as a block or a guide rail and especially equipped with an image sensor 60 for example in order to attain further information about the edge of the hand. The image sensor 60 is also, for example, slightly recessed in comparison with the contact area, in order to avoid staining. The image sensor 60 extends, for example, at right angle across the support area. 1.

Moreover it is possible to provide in the contact area 6, for example, contact spots or contact sensors in order to detect the presence of a hand to be recorded. By triggering this sensor it is possible to initiate the recording process.

Moreover the invention provides that a majority of splaying means 5 are provided which, once the hand 2 is inserted into the device, spread out in the space between the individual fingers 20. At the same time they limit the insertion range of the hand 2 into the device.

In the front part of the device, especially in the area of the fingers 20, the finger superficies surface recognition arrangement 7 is placed (see FIG. 2). It serves to record the superficies surface of the finger 2. The specific modification of this arrangement is demonstrated in FIG. 3 in particular.

In FIG. 1 it is demonstrated that for each of the fingers 20 there is one finger superficies surface recognition arrangement 7 provided. Thus it is possible to record all fingers in one operational step and possibly also the lines of the thumb which is insofar to be considered as a finger as well.

To avoid incorrect recordings of images the support area 1 is excepted from the finger superficies surface recognition arrangement 7, to have no stained support areas.

The mode of operation of the finger superficies surface recognition arrangement 7 results especially from FIG. 3. But it results as well from the international patent application PCT-EP 2005-001230 of the applicant. As already described the contents of this international patent application is referred to in its full scope.

By the relative movement 4 of the hand 2 the finger 2 is drawn back through the ring-shaped deflection mirror 70. Illumination 72 is provided which illuminates the finger superficies surface of the finger. The light thus radiating will be projected via the deflection mirror 70 and an image optics 71 (compare FIG. 2) to the image recording unit 73.

In an idealised way the finger 20 corresponds to a cylinder. The deflection mirror is of truncated conical shape and images a sleeve-shaped finger superficies surface in a circular disk. The further image editing is in this case computer-controlled.

By the draw-back movement 4 eventually a film is recorded about the surface of the superficies surface via the image recording unit 73. This image is converted to a complete image by electronic image processing.

One fundamental advantage of the invention lies especially in the fact that simultaneously complex data, e.g. the superficies surface of the finger, as well as comparatively easily obtained data of the bottom side of the hand respectively the bottom side of the fingers with the respective lines can be obtained.

The test person puts his hand into the device according to the invention, the fingers 2 are splayed by the splaying means 5 in a way that the individual fingers 20 are assigned to the respective finger superficies surface recognition arrangements 7. For example on one splaying means 5 an image recording scanner 8 is provided. This scanner has the function of a switch and actuates the automatic recording operation. While now the test person draws back his hand the superficies surface of each finger is recorded by the finger superficies surface recognition arrangement 7 and at the same time respectively in immediate succession, however, in any case during the draw-back movement 4 the hand bottom side is recorded by the line sensor 3. At any rate there are alternatively also side images recorded by the image recorders 60. The recording of these two different image groups is effected simultaneously, whereas, of course, at first with respect to the fingers the finger superficies surface is recorded and afterwards, once the fingers have been drawn back accordingly, the line sensor as a sensor records the lines of the fingers on the finger bottom side. The arrangement is chosen in a way that the line sensor 3 records one complete image, especially in order to determine the geometric position of individual fingers to make sure that images cannot be manipulated or mixed up. The aim is, for example, to be able to assign the data field “little finger” reliably to the image situiated at the very left. For this purpose it is also provided by the device according to the invention that a comparison, a control or an allocation of the recorded finger superficies surfaces to the respectively recorded finger bottom sides of the fingers is effected. In addition one complete image of the lines of the hand is obtained which is also interesting for biometric data collection.

In FIG. 4 one more modification of the device according to the invention is described. The hand 2 is in this case inserted into the device, the deflection mirrors 70′, 70″ are, for example, executed as ring-shaped deflection mirrors. It has to be ensured that the deflection mirror 70″ of the middle finger 20″ is arranged in a distanced position to the root of the finger. It does not form a straight line with its adjacent, further deflection mirror, the mirror 70′ of the neighbouring finger superficies surface recognition arrangement 7′ is slightly recessed. The sketch shows that the deflection mirrors 70′, 70″ are considerably larger than the diameter of the fingers 20′, 20″. In order to avoid a collision with the neighbouring deflection mirrors 70′, 70″, the deflection mirrors are arranged in staggered position, especially with respect to the draw-back movement 4. By doing so space is saved.

FIG. 5, 6 describe another embodiment of the finger superficies surface recognition arrangement according to the invention. FIG. 5 does in this case not completely correspond to a lateral view according to FIG. 6. For the sake of clarity the mirror 702 was not included in the view according to FIG. 5.

Contrary to the modification according to FIG. 2, for example, for the modification according to FIG. 5, 6 a majority of individual deflection mirrors 701, 702, 703, 704, 705 is provided, which are arranged along the circumference of the finger in stripe-like arrangement.

Contrary to the modification according to FIG. 2, in which a ring-shaped or a half-ring-shaped deflection mirror 70 is used, small deflection mirrors 701, 702, 703, 704, 705 are used here. Although these are here designed with a distance in between they are actually bluntly in contact to each other in order to deliver a comprising image of the finger superficies surface. For increasing the clarity they were designed in distance to each other.

A modification of this kind results in definitely lower costs for creating a deflection mirror 70 of this kind, as these can each be designed as individual, in particular planar or plane deflection mirrors.

Another advantage of the invention is that the image recording unit 73 in the modification example as demonstrated here is designed as a line sensor and delivers a virtually one-dimensional image. The drawing in FIG. 6 is in this case very schematic. Preferably it is to be provided that the sensor used here is a colour sensor respectively a colour camera in order to—this will be described later—utilise the effect of fractal light, especially for the generating of a three-dimensional image of the finger superficies surface.

The arrangement is now chosen in a way that the left area of the finger superficies surface (according to FIG. 6) of the finger 2 is imaged by means of the deflection mirror 701 to the very left via the optical way 791 to the area 731 of the sensor 73. Thus respective different image areas are defined, whereas it is especially convenient that the different finger superficies surfaces are imaged on one line sensor 73. As the individual mirrors 701 to 705 are each next to another a complete image is achieved.

That way for example the middle, lower area of the finger 2 is displayed on the small way 793 via the deflection mirror 703 on the middle area 733 of the image recording unit 73. The individual, respectively neighbouring areas that image the areas of the finger superficies surfaces, are marked with 731 to 735. It has to be pointed out that the arrangement of FIG. 6 is very schematic.

The chosen arrangement is here provided in a way that the image recording unit 73 is recessed with regard to the draw-back movement 4 from the arrangement of the deflection mirrors 701 to 705 (compare FIG. 5). Thus it is possible to implement a complete image of the finger superficies surface of the finger 2 on a line sensor as image recording unit 73.

Favourable manufacturing costs for the individual deflection mirror 701 to 705 are here combined with a simple image recording unit 73 which especially ensures very quick readout, namely if it is designed as a line sensor.

Moreover the suggestion according to the invention is to design the image recording unit 73 in the execution example as demonstrated in FIG. 5 respectively FIG. 6 especially as a colour sensor. The arrangement can in this case again be either in the form of a two-dimensional sensor or of a line sensor. The use of a colour sensor as image recording unit, however, provides the possibility to generate after the effect of fractal light a three-dimensional image in the image processing in a simple way.

Within the scope of this application the applicant reserves the right to claim independent protection for the different aspects of the invention as mentioned in this application. In particular the applicant reserves the right to apply for independent protection, for example within the scope of a partial application for the object according to FIG. 5, 6 respectively for the use of the effect of fractal light for generating a three-dimensional image of a finger superficies surface. In this case the applicant particularly reserves the right to make the aforementioned features independently the subject of independent applications and to claim these and understand these independent from the object as described in claim 1 for example. At the same time the applicant reserves the right to consider all other features in a suitable way, in particular for avoiding unnecessary repetitions as herewith disclosed and described. The applicant especially reserves the right to combine the features in any possible combination, thus these are also disclosed.

The claims as handed in now with the application and at a later date are attempts of formulation without prejudice regarding the attainment of any further protection.

Should on the basis of more specific investigation, also in particular of the relevant state of the art, the findings be that one or another feature may be convenient, but not of major importance for the aim of the invention, it goes without saying that already now it is aimed for a formulation which does no longer include this sort of feature, especially in the main claim.

The reverting relations in the dependent claims refer to the further execution of the object of the main claim by the features of the respective sub-claim. These are, however, not to be understood as a waiver for attainment of an independent, objective protection for the features of the related sub-claims.

Features that were so far only disclosed in the description can in the course of the procedure be claimed to be of essential importance for the invention, for example to distinguish it from the state of the art.

Features that were disclosed in the description only or individual features from claims that comprise a majority of features can at any time be transferred into the first claim to distinguish it from the state of the art, even in cases where these features were stated in connection with other features respectively achieve particularly convenient results in combination with other features.

1-37. (canceled)

38. Device for the recording of the lines of the fingers respectively the hand wherein the device has a support area for the hand respectively the fingers, characterised in that in the support area a line sensor is provided covering the whole width of the hand, and the device has at least one finger superficies surface recognition arrangement.

39. Device according to claim 38, characterised in that the surface of the line sensor facing the hand is recessed in comparison with the support area.

40. Device according to claim 38, characterised in that the length of the support area is dimensioned in such a way that the complete hand can rest on it.

41. Device according claim 38, characterised in that an arrangement of several line sensors is provided one beside the other or staggered one beside the other.

42. Device according claim 38, characterised by a small width of the line sensor in proportion to the length of the hand.

43. Device according to claim 38, characterised by a relative movement, in particular a draw-back movement of the hand regarding the line sensor for recording the lines of the hand or the fingers.

44. Device according to claim 38, characterised by a relative movement of the line sensor.

45. Device according to claim 38, characterised by several splaying means for the fingers that are arranged at, on, or above the support area.

46. Device according to claim 38, characterised by at least one lateral contact area for guiding the side of the hand or the edge of the hand.

47. Device according to claim 38, characterised in that at least one lateral contact area is provided for guiding the side of the hand or the edge of the hand, and the contact area equipped with an image sensor.

48. Device according to claim 38, characterised in that at lest on lateral contact area is provided for guiding the side of the hand or the edge of the hand, and the image sensor is recessed in comparison with the contact area.

49. Device according to claim 38, characterised in that the hand is guided on each side by one contact area.

50. Device according to claim 38, characterised in that for each finger one individual finger superficies surface recognition arrangement is provided.

51. Device according to claim 38, characterised by a relative movement of the hand relatively to the device.

52. Device according to claim 38, characterised in that the finger superficies surface recognition arrangement consists of a deflection mirror, and, if-necessary, image optics as well as an image recording unit.

53. Device according to claim 38, characterised in that the deflection mirrors of neighbouring finger superficies surface recognition arrangements are arranged in staggered position to each other.

54. Device according to claim 38, characterised in that the finger superficies surface recognition arrangement comprises several deflection mirrors, and each deflection mirror images individual regions of the finger superficies surface.

55. Device according to claim 38, characterised in that the finger superficies surface recognition arrangement comprises an image recording unit is a plane image sensor or a line sensor.

56. Device according to claim 38, characterised in that the finger superficies surface recognition arrangement comprises an image recording unit, and the image recording unit or the line sensor is a colour camera.

57. Device according to claim 38, characterised in that the finger superficies surfaces recognition arrangement comprises an image recording unit, and the image recording unit is a plane image sensor or a line sensor, and several deflection mirrors are provided, and the finger superficies surfaces as imaged by one of several deflection mirrors are each recorded by one area of the sensor, preferably by the line sensor.

58. Device according to claim 38, characterised in that the finger superficies surface recognition arrangement comprises an image recording unit, and the image recording unit is a plane image sensor or a line sensor, and several deflection mirrors are provided, and neighbouring deflection mirrors image the finger superficies surface regions on neighbouring sensor areas of the line sensor.

59. Device according to claim 38, characterised in that the finger superficies surface recognition arrangement comprises an image recording unit, and the image recording unit is a plane image sensor or a line sensor, and several deflection mirrors are provided, and for each deflection mirror one individual sensor is provided.

60. Device according to claim 38, characterised by the use of light with different wave lengths for illumination of the finger or the hand, in particular to produce a three-dimensional image of the finger superficies surface or the hand on the line sensor or the image recording unit of the finger superficies surface recognition arrangement.

61. Device according to claim 38, characterised in that the deflection mirror is provided, and the deflection mirror shaped like a ring or half ring, plane, planar or like a truncated cone.

62. Device according to claim 38, characterised in that a deflection mirror is provided, and the deflection mirror is shaped like a ring or half ring, plane, planar or like a truncated cone, and the deflection mirror has an arc angle from 0° to 360°, preferably from 0° to 220°, in particular preferably from 0° to 180°.

63. Device according to one claim 38, characterised in that the finger superficies surface recognition arrangement is provided by an individual line sensor.

64. Device according to claim 38, characterised in that the line sensor, the finger superficies surface recognition arrangement, and the image sensor are provided, and the image sensor or the contact area are each designed in a modular way.

65. Device according to claim 38, characterised in that the device is designed in a modular way and, if necessary, can be equipped with a finger superficies surface recognition arrangement and/or the image sensor or the contact area.

66. Device according to claim 38, characterised in that an image recording scanner is provided, in particular at a splaying means which serves for starting the recording of the finger line or superficies surface line and/or the individual finger superficies surface.

67. Device according to claim 38, characterised in that the deflection mirror is provided, and the deflection mirrors is arranged in the vicinity of the splaying means.

68. Recording device for recording the finger or hand lines of a test person, characterised by a double, preferably mirrored arrangement of two devices according to claim 38.

69. Method for recording finger or hand lines, whereby the recording of the finger superficies surface is carried out at the same time as the recording of the hand lines.

70. Method according to claim 69, characterised in that first of all the finger superficies surface is recorded, in particular by one or more finger superficies surface recognition device(s), and, after that, a sensor records the finger lines of the bottom side of the fingers.

71. Method according to claim 69, characterized in that first of all the finger superficies surface is recorded, in particular by one or more finger superficies surface recognition device(s), and, after that, a sensor records the finger lines of the bottom side of the fingers, and a comparison, a control or an allocation of the recorded finger superficies surfaces to the respectively recorded bottom sides of the fingers is carried out.

72. Method according to claim 69, characterised by an image correction step for eliminating the trembling movements of the hand.

73. Method according to claim 69, characterised in that, when light with different wave lengths and/or a colour camera is used, a three-dimensional image of the finger superficies surface or the hand is created.

74. Method according to claim 69, characterised in that first of all, the hand is inserted in a device for recording the finger or hand lines, in particular a device where a support area for the hand or the fingersis provided, and in the support area a line sensor covering the complete width of the hand is provided, and the device has at least one finger superficies surface recognition arrangement, an image recording scanner arranged in the device is actuated, and, during the draw-back movement of the hand out of the device, the hand or finger lines as well as the finger superficies surface is/are recorded.
